(19) United States
(12) Patent Application Publication
(10) Pub. No.: US 2018/0243985 A1
(43) Pub. Date: Aug. 30, 2018

(54) EXTRUDERS TO FEED FILAMENTS

(71) Applicant: HEWLETT-PACKARD DEVELOPMENT COMPANY, L.P., Houston, TX (US)

(72) Inventor: James Frenock, Lebanon, OR (US)

(21) Appl. No.: 15/757,573

(22) PCT Filed: Jan. 19, 2016
(86) PCT No.: PCT/US2016/013890

§ 371 Date: Mar. 5, 2018

(51) Int. Cl. B29C 64/209; B29C 64/118; B33Y 10/00; B33Y 30/00

(52) U.S. Cl. CPC B29C 64/209; B33Y 30/00; B33Y 10/00; B29C 64/118

(57) ABSTRACT

In some examples, an apparatus for a printer comprises an extruder assembly comprising a plurality of extruders to feed respective filaments for deposition during a printing process, and a motor to drive engagement surfaces in the plurality of extruders when feeding the respective filaments in a feed direction. The extruder assembly further comprises moveable elements, each respective moveable element of the moveable elements to selectively disengage a respective filament of the filaments from a respective engagement surface of the engagement surfaces, the respective filament disengaged from the respective engagement surface in a direction different from the feed direction of the respective filament.

### BACKGROUND

Three-dimensional (3D) printing can be used to form 3D objects. In 3D printing (also referred to as additive manufacturing), successive layers of materials are formed to build a 3D object based on a 3D computer model.

### BRIEF DESCRIPTION OF THE DRAWINGS

Some implementations of the present disclosure are described with respect to the following figures.

FIG. 1 is a block diagram of an example printer assembly according to some examples.

FIG. 2 is a perspective side view of an example printer assembly according to further examples.

FIG. 3A is a perspective side view of a portion of an extruder assembly according to further examples.

FIG. 3B is a side view of a portion of an extruder assembly according to alternative examples.

FIG. 4 is a block diagram of a three-dimensional (3D) printer according to some examples.

FIG. 5 is a flow diagram of an example process according to some examples.

### DETAILED DESCRIPTION

In some examples, three-dimensional (3D) printing can deposit a flowable build material to form a 3D object based on a computer model. One type of 3D printing is referred to as fused deposition modeling (FDM) printing, in which a flowable build material (also referred to as a flowable extrusion material) in the form of a filament is fed through an extruder assembly of a 3D printer to deposit the flowable build material onto a build platform to form a 3D object within a build chamber of the 3D printer. As used in the present disclosure, the term “printer” can refer to any printing system that is used to form an object. A “3D printer” can refer to a printer that can form a 3D object based on a computer model, where the 3D object is formed based on additive manufacturing by adding successive layers of print material(s). A “filament” can refer to a flowable build material (also referred to as a flowable extrusion material) in an elongate shape that can be fed through an extruder assembly of a printer to a portion of the printer where the filament can be melted or liquefied for deposition towards the build platform. The filament can be a solid or in powdered form, and is flowable when in the hot state. The portion of the printer for melting the filament can also be referred to as a hot end of the printer. The extruder assembly for feeding the filament can be referred to as the cold end of the printer. A heat insulating mechanism can be provided between the cold end of the printer and the hot end of the printer to reduce the amount of heat generated at the hot end that travels to the cold end.

In some cases, to increase throughput or flexibility of a printer, multiple filaments of flowable build material can be fed through the extruder assembly of a printer. The multiple filaments can be formed of materials having the same or different characteristics, where examples of characteristics include a type of material (e.g. thermoplastic, metal, or any other material that can be used as part of a 3D printing process to form layers of a 3D object), a color of the material, or some other characteristic.

A drive mechanism that is used to feed multiple filaments through the extruder assembly of a printer can be complex. For example, multiple motors can be used to feed respective filaments through the extruder assembly. The use of multiple motors can add to the complexity and cost of the printer.

In accordance with some implementations of the present disclosure, a printer assembly to feed multiple filaments through a printer is provided that can use one motor to drive the feeding of multiple filaments through a 3D printer. By being able to feed multiple filaments in a 3D printer, large 3D objects can be formed in a smaller amount of time. Also, flexibility in printing 3D objects can be enhanced since filaments of the same or different characteristics can be simultaneously deposited during the printing process.

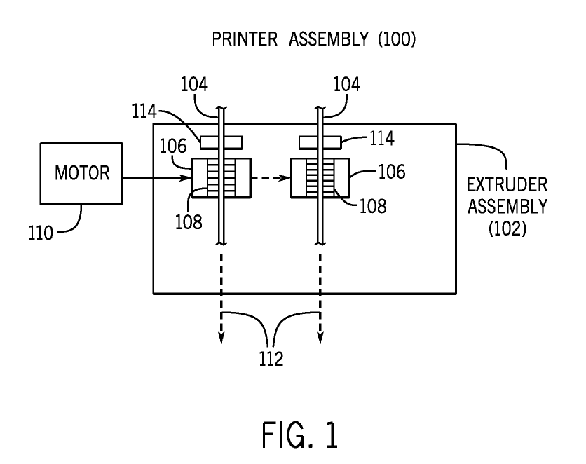

FIG. 1 shows a printer assembly 100 that can be provided as part of a 3D printer. The printer assembly 100 includes an extruder assembly 102 for extruding filaments of flowable build material from respective filament sources (not shown in FIG. 1), where the filament sources can be in the form of spools of the filaments 104.

The extruder assembly 102 includes extruders 106 to feed the filaments 104 through the extruder assembly 102 for deposition onto a target on a build platform of the 3D printer, during a printing process. The filaments 104 are fed by the extruders 106 towards a hot end of the printer where the filaments 104 can be melted (also referred to as “liquefied”) for deposition onto the target on the build platform.

The filaments 104 can share a common characteristic or can have different characteristics. For example, at least two filaments 104 can be formed of the same material or be of different materials, can have the same color or be of different colors, and so forth.

Each of the extruders 106 includes an engagement surface 108 to which the respective filament 104 can be engaged. A motor 110 is used to drive movement of the extruders 106, where the movement can be rotational movement in which the extruders 106 are rotated by the motor 110. In some examples, the motor 110 can be a stepper motor or other type of motor. In general, a “motor” can refer to any drive mechanism that is able to cause movement of the extruders 106 to feed the filaments 104 when engaged to the respective engagement surfaces 108 through the extruder assembly 102 in a feed direction 112. In some examples, the filaments 104 can be fed in the same feed direction. In other examples, the feed direction of one filament 104 can be different from the feed direction of another filament 104. Thus, as used in this disclosure, feeding multiple filaments in a feed direction can refer to feeding the multiple filaments in one or multiple feed directions.

In the example arrangement of FIG. 1, one motor 110 is used to drive multiple extruders 106 to feed the multiple filaments 104 through the extruder assembly 102. Use of one motor 110 can reduce the complexity and cost of the printer assembly 100, and can increase the reliability of the printer assembly 100 by reducing the number of parts.

The extruder assembly 102 also includes moveable elements 114 that are moveable by an actuator assembly (not shown in FIG. 1) to move the moveable elements 114 between an engaged position and a released position. The moveable elements can be moved back and forth in a direction that is different from the feed direction 112. Movement of a moveable element 114 in a first direction (e.g. generally into the page of FIG. 1) allows the respective filament 104 to engage the corresponding engagement surface 108. Movement of the moveable element 114 in a second direction (e.g. generally out of the page of FIG. 1) causes disengagement of the respective filament 104 from the corresponding engagement surface 108. More specifically, in some examples, movement of a moveable element 114 in the second direction pulls the respective filament 104 away from the corresponding extruder 106, while movement of the moveable element 114 in the first direction allows the filament 104 to be pushed towards the engagement surface 108 of the corresponding extruder 106.

When a filament 104 is disengaged from the respective engagement surface 108, rotation of the corresponding extruder 106 would not cause the filament 104 to move the filament 104 in the feed direction 112. In some implementations, as discussed in further detail below, the moveable element 114 when disengaging a filament 104 from the corresponding extruder 106 can also slightly pull the filament 104 upwardly (or more generally in a direction opposite the feed direction 112) to retract the filament 104 from the hot end of the 3D printer. Retracting a filament from the hot end of the 3D printer when the filament is not in use can reduce the amount of the filament that can drip out of the hot end.

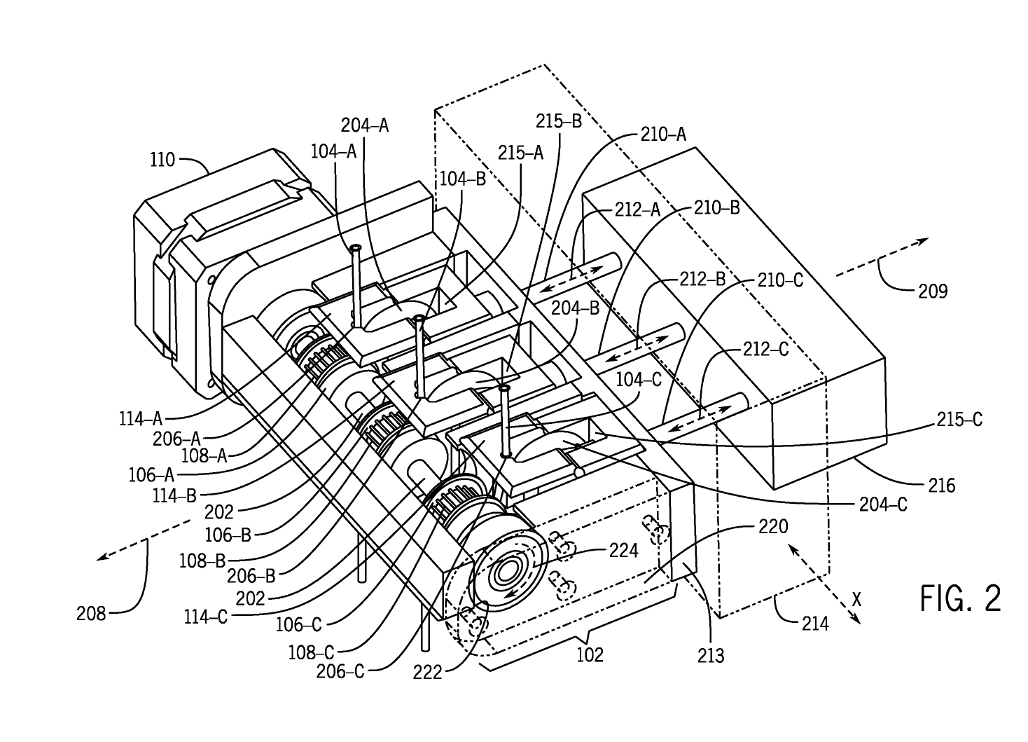

FIG. 2 is a perspective view of the printer assembly 100, the motor 110, an actuator 216, and a carriage assembly 214, in accordance with further implementations. Although a specific example arrangement is shown in FIG. 2, it is noted that in other examples, other arrangements can be employed.

The extruder assembly 102 includes a drive shaft 202 that is rotatable by the motor 110 in a rotational direction 224. Extruders 106-A, 106-B, and 106-C are mounted on the drive shaft 202, such that rotation of the drive shaft 202 causes corresponding rotation of the extruders 106-A, 106-B, and 106-C in the same rotational direction 224. Each extruder 106 (106-A, 106-B, or 106-C) includes a corresponding engagement surface 108 (108-A, 108-B, or 108-C, respectively). In some examples, each engagement surface 108 has a geared or hobbed profile, which has gears, teeth, or splines that are cut into a surface of the extruder 106. In FIG. 2, three filaments are shown, identified as filaments 104-A, 104-B, and 104-C. In other examples, a different number of filaments can be fed by a corresponding different number of extruders through the extruder assembly 102.

The extruder assembly 102 further includes moveable elements 114-A, 114-B, and 114-C, where the moveable elements are moveable to cause the respective filament to be engaged with a respective engagement surface 108-A, 108-B, or 108-C, or to be disengaged from the respective engagement surface. In the example of FIG. 2, the moveable elements 114-A, 114-B, and 114-C are holders. The holders 114-A and 114-B are in an engaged position, while the holder 114-C is in a released position. In the engaged position, the holders 114-A and 114-B cause the filaments 104-A and 104-B to be engaged to respective engagement surfaces 108-A and 108-B. Each holder 114-A or 114-B includes a cylindrical bearing 204-A or 204-B, respectively. The cylindrical bearings 204-A and 204-B are provided in respective receptacles 215-A and 215-B of the holders 114-A and 114-B. When the holders 114-A and 114-B are in the engaged position, the corresponding bearings 204-A and 204-B push the respective filaments 104-A and 104-B to engage the corresponding engagement surfaces 108-A and 108-B.

The holder 114-C also includes a receptacle 215-C to receive a cylindrical bearing 204-C. The holder 114-C in the released position has pulled the respective filament 104-C away from the engagement surface 108-C, such that the filament 104-C is disengaged from the engagement surface 108-C. The holder 114-C has a slot 206-C that grabs in the filament 104-C when the holder 114-C is moved to the released position. Each of the holders 114-A and 114-B similarly include grooves 206-A and 206-B, except that when the holders 114-A and 114-B are in the engaged position, the grooves 206-A and 206-B do not pull the filaments 104-A and 104-B away from the respective engagement surfaces 108-A and 108-B.

In other examples, instead of using cylindrical bearings 204-A, 204-B, and 204-C in the holders 114-A, 114-B, and 114-C, other types of structures can be used.

Generally, each holder 114 (114-A, 114-B, 114-C) is moveable between the engaged position and the released position. A holder 114 is moveable generally along a first direction 208 to move the holder 114 to the engaged position, and the holder 114 is moveable along a second direction 209 that is opposite the first direction 208 to move the holder 114 to the released position.

When a holder 114 (e.g. holder 114-A or 114-B) is in the engaged position, the respective filament 104 (e.g. filament 104-A or 104-B) is considered to be active and is fed through the extruder assembly 102 by rotation of the drive shaft 202 by the motor 110. When a holder 114 (e.g. holder 114-C) is in the released position, the respective filament 104-C is considered to be inactive and is not fed through the extruder assembly 102.

In other examples, other types of moveable elements can be employed that are different from the holders 114-A, 114-B, and 114-C, for engaging and disengaging respective filaments with respect to corresponding extruders 106-A, 106-B, and 106-C.

Each holder 114-A, 114-B, or 114-C is operatively coupled to a connecting rod 210-A, 210-B, or 210-C, respectively. The connecting rods 210-A, 210-B, and 210-C are moveable back and forth along respective axes 212-A, 212-B, and 212-C by an actuator 216. The connecting rods 210-A, 210-B, and 210-C extend through a wall 213 between the extruder assembly 102 and a carriage assembly 214.

In some examples, the actuator 216 can be a solenoid actuator that is responsive to electrical signals to cause movement of the connecting rods 212-A, 212-B, and 212-C using magnetic fields. In other examples, other types of actuators can be employed. The connecting rods 212-A, 212-B, and 212-C are individually controllable by the actuator 216.

The extruder assembly 102 is attached to the carriage assembly 214, which is moveable along an X direction (as shown in FIG. 2).

The extruder assembly 102 includes a housing 220, which can be formed of a metal, plastic, or other material. The housing 220 defines a partial cylindrical groove 222 in which an assembly including the drive shaft 202 and extruders 106-A, 106-B, and 106-C is received.

In operation, the motor 110 when activated causes rotation of the drive shaft 202 (and the corresponding extruders 106-A, 106-B, and 106-C) along the rotational direction 224. Rotation of the extruders 106-A, 106-B, and 106-C cause corresponding rotational movement of the engagement surfaces 108-A and 108-B along the rotational direction 224, which causes the engaged filaments 104-A and 104-B to be fed in the feed direction 112. However, since the filament 104-C is disengaged from the engagement surface 108-C by the holder 114-C, the rotational movement of the engagement surface 108-C in the rotational direction 224 does not cause the feeding of the filament 104-C in the feed direction 112. Rather, the filament 104-C remains stationary despite the rotational movement of the engagement surface 108-C.

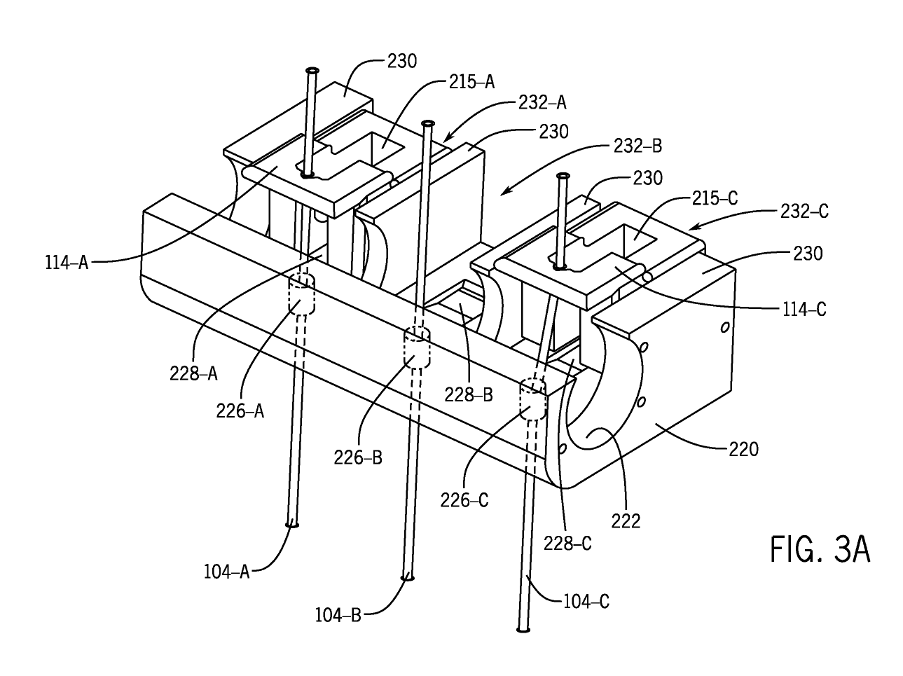

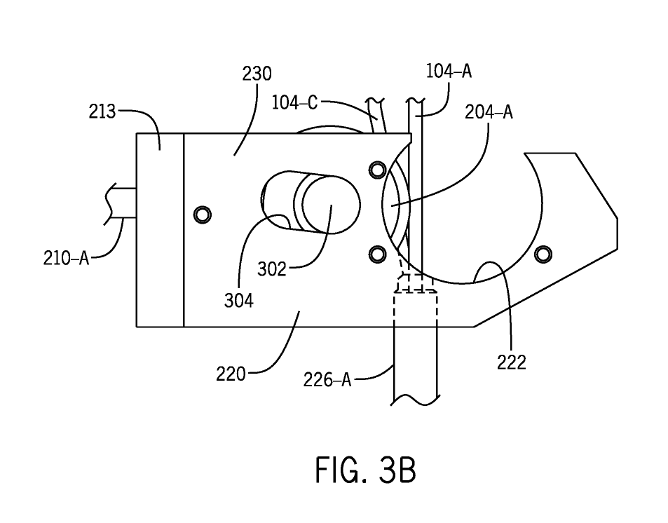

Reference is further made to FIG. 3A in the ensuing discussion. FIG. 3A is a perspective view of a portion of the extruder assembly 102 of FIG. 2, with certain parts removed. In FIG. 3A, the holder 114-B has been omitted, but the holders 114-A and 114-C are shown. Also, the cylindrical bearings 204-A and 204-C are omitted from the respective receptacles 215-A and 215-C of the holders 114-A and 114-C.

The filaments 104-A, 104-B, and 104-C pass through respective slots 226-A, 226-B, and 226-C that are formed in the extruder assembly 102. The slots 226-A, 226-B, and 226-C allow the filaments 104-A, 104-B, and 104-C to pass through the extruder assembly 102.

As shown in FIG. 3A, the holder 114-A is in the engaged position, while the holder 114-C is in the released position. The holder 114-C in the released position is both lifted upwardly and pushed backwardly with respect to the holder 114-A that is in the engaged position. The lifting of the holder 114-C during retraction of the holder 114-C backwardly to the released position is due to engagement of the cylindrical bearing 204-C with respect to a bearing surface 228-C of the housing 220 of the extruder assembly 102. As the connecting rod 212-C (FIG. 2) is moved backwardly by the actuator 216, the cylindrical bearing 204-C pushes up against the bearing surface 228-C to cause the holder 114-C to be lifted upwardly as the holder 114-C is moved backwardly to the released position. As the holder 114-C is lifted, the groove 206-C of the holder 114-C grabs the filament 104-C and lifts the filament 104-C up.

In contrast, when a connecting rod (e.g. connecting rod 212-A) is moving the opposite direction to push the holder 114-A to the engaged position, the cylindrical bearing 204-A is moved away from the bearing surface 228-A such that the holder 114-A can descend downwardly as the cylindrical bearing 204-A releases from the bearing surface 228-A and the connecting rod 212-A pushes the holder 114-A towards the engaged position.

As further shown in FIG. 3A, walls 230 of the housing 220 define respective chambers 232-A, 232-B, and 232-C in which the respective holders 114-A, 114-B, and 114-C are received.

In alternative implementations, the lifting of the holder 210-A, 210-B, or 210-C can be accomplished using an arrangement as shown in FIG. 3B. FIG. 3B is a side view of a portion of the extruder assembly 102, and shows that the wall 230 of the housing 220 of the extruder assembly 102 has an inclined slot 304 along which a bearing shaft 302 of the bearing 204-A is moveable. As the holder 114-A is pulled backwardly by the connecting rod 210-A, the bearing shaft 3402 slides along inclined slot 304 as the bearing 302 rotates. The inclination of the inclined slot 304 (which rises from the front to the rear of the wall 230) causes the holder 114-A to be lifted as the bearing shaft 302 moves along the inclined slot 304.

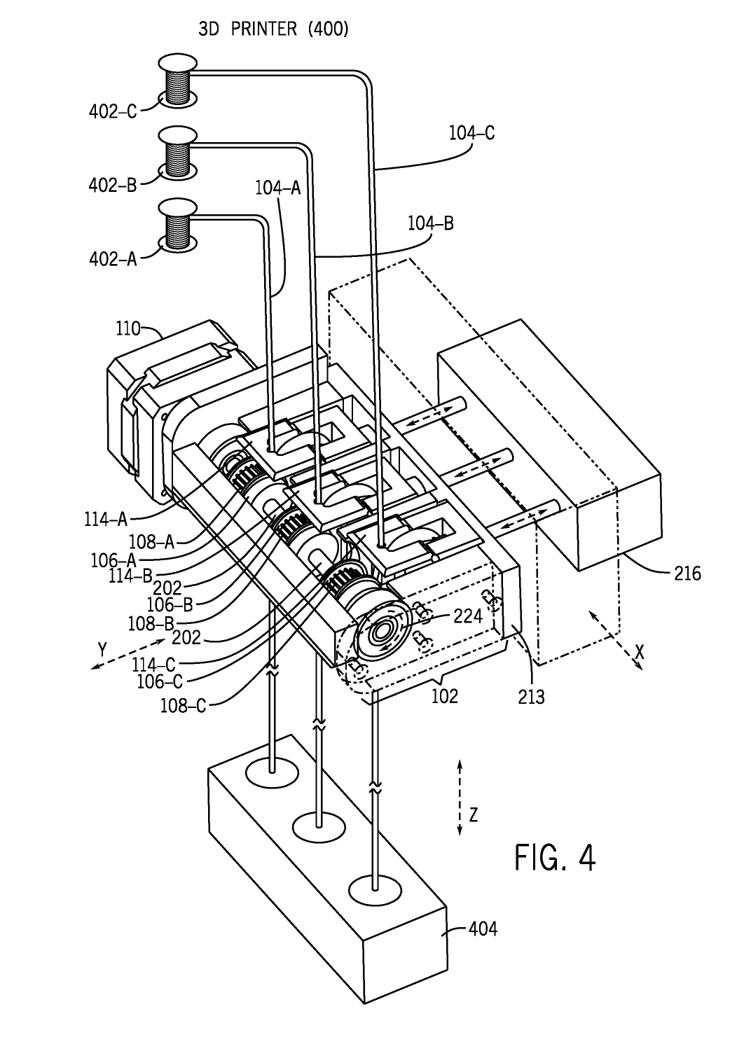

FIG. 4 is a block diagram of an example 3D printer 400 according to some implementations. The 3D printer 400 includes a nozzle assembly 404 to which the filaments 104-A, 104-B, and 104-C are fed by the extruder assembly 102. The nozzle assembly 404 includes heating elements to heat filaments 104-A, 104-B, and 104-C, to melt the elements such that the melted build material(s) of the filaments can be deposited onto a target on a build platform (now shown) below the nozzle assembly 404.

The extruder assembly 102 includes the extruders 106-A, 106-B, and 106-C that are used to feed the filaments 104-A, 104-B, and 104-C from respective filament spools 402-A, 402-B, and 402-C to the nozzle assembly 404. The extruder assembly 102 includes the rotatable drive shaft 202 on which the extruders 106-A, 106-B, and 106-C are mounted. The extruders 106-A, 106-B, and 106-C are rotatable by rotation of the shaft 202 (such as when the motor 110 in FIG. 1 or 2 is activated). Each extruder includes a respective engagement surface 108-A, 108-B, and 108-C, respectively.

In addition, the extruder assembly 102 includes moveable elements 114-A, 114-B, and 114-C that are moveable by the actuator 216 between an engaged position and a released position. A respective moveable element 114 (114-A, 114-B, or 114-C) when in the engaged position causes a respective filament 104 (104-A, 104-B, or 104-C) to be engaged to a respective engagement surface 108 (108-A, 108-B, or 108-C), and the respective moveable element 114 when in the released position causes the respective filament 104 to be disengaged from the respective engagement surface 108.

As further shown in FIG. 4, the 3D printer 400 has three axes: X, Y, and Z. The extruder assembly 102 is moveable in the X direction, such as by movement of the carriage assembly 214 (FIG. 2) on a rail or other support structure.

The extruder assembly 102 is also moveable in the Y direction, as well as in the Z direction, based on moving along respective rails or other support structures.

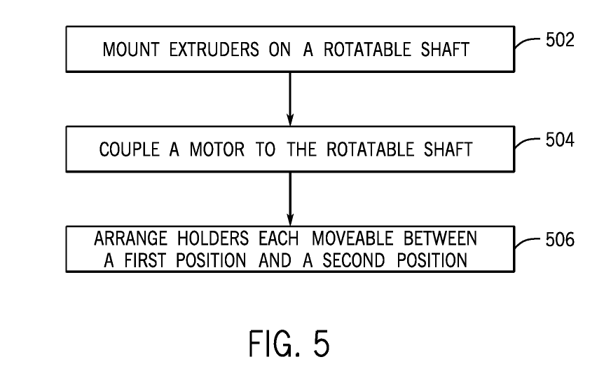

FIG. 5 is a flow diagram of an example process of forming a printer assembly (e.g. a printer assembly 100 of FIG. 1 or other printer assembly described herein), for use in a 3D printer. The method includes mounting (at 502) extruders (e.g. 106-A, 106-B, and 106-C) on a rotatable drive shaft (e.g. 202) to feed respective filaments (e.g. 104-A, 104-B, and 104-C) for deposition during a printing process. The method further includes coupling (at 504) a motor (e.g. 110 in FIG. 1 or 2) to the rotatable drive shaft, the motor when activated rotating the rotatable shaft to cause rotation of the extruders for feeding the respective filaments in a feed direction.

The method further includes arranging (at 506) holders (e.g. 114-A, 114-B, and 114-C) each moveable between a first position (engaged position) and a second position (released position), each respective holder of the holders when in the first position causing a respective filament of the filaments to be engaged to a respective extruder of the extruders, and the respective holder when in the second position causing the respective filament to be disengaged from the respective extruder.

In some implementations, the 3D printer can include machine-readable instructions executable by a processor (or processors) of the 3D printer to control the printing process. The machine-readable instructions can control which of the filaments are active (engaged to a respective extruder) and which are inactive (disengaged from a respective extruder).

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus for a printer, comprising:
an extruder assembly comprising a plurality of extruders to feed respective filaments for deposition during a printing process; and
a motor to drive engagement surfaces in the plurality of extruders when feeding the respective filaments in a feed direction,
the extruder assembly further comprising moveable elements, each respective moveable element of the moveable elements to selectively disengage a respective filament of the filaments from a respective engagement surface of the engagement surfaces, the respective filament disengaged from the respective engagement surface in a direction different from the feed direction of the respective filament.

2. The apparatus of claim 1, wherein the motor is to cause simultaneous driving of multiple filaments of the filaments when the multiple filaments are engaged with corresponding engagement surfaces of the engagement surfaces.

3. The apparatus of claim 1, further comprising a drive shaft rotatable by the motor, the drive shaft comprising the engagement surfaces to engage the respective filaments, the engagement surfaces rotatable to feed the respective filaments through the extruder assembly.

4. The apparatus of claim 3, further comprising an actuator assembly to control movement of the moveable elements to selectively engage and disengage the filaments with respect to the engagement surfaces.

5. The apparatus of claim 4, wherein the actuator assembly comprises a plurality of rods that are moveable back and forth to selectively move the moveable elements.

6. The apparatus of claim 5, wherein each respective moveable element of the moveable elements is to release from a respective filament of the filaments to allow engagement of the respective filament with the respective engagement surface in response to a respective rod of the rods moves in a first direction, and the respective moveable element is to grab the respective filament to disengage the respective element from the respective engagement surface in response to the respective rod moving in a second, different direction.

7. The apparatus of claim 6, wherein the moveable elements are holders, the apparatus further comprising a respective bearing in each respective holder of the holders, the bearing to push the respective filament towards a respective engagement surface of the engagement surfaces in response to the respective rod moving in the first direction, and the bearing to raise the respective holder and to cause the respective holder to grab the respective filament in response to the respective rod moving in the second direction.

8. The apparatus of claim 1, wherein the engagement surfaces comprise geared surfaces.

9. A three-dimensional (3D) printer comprising:
a nozzle assembly to melt filaments;
an actuator;
an extruder assembly comprising a plurality of extruders to feed the filaments from respective filament spools to the nozzle assembly, the extruder assembly comprising:
a rotatable shaft on which the plurality of extruders are mounted, the extruders rotatable by rotation of the rotatable shaft, and each extruder of the plurality of extruders comprising a respective engagement surface to engage a respective filament of the filaments,
a plurality of moveable elements moveable by the actuator between an engaged position and a released position, wherein a respective moveable element of the plurality of moveable elements when in the engaged position causes a respective filament of the filaments to be engaged to the respective engagement surface, and the respective moveable element when in the released position causes the respective filament to be disengaged from the respective engagement surface.

10. The 3D printer of claim 9, wherein each respective moveable element of the plurality of moveable elements includes a profile to grip the respective filament to lift the respective filament as the respective moveable element is moved to the released position.

11. The 3D printer of claim 10, wherein each respective moveable element of the plurality of moveable elements is lifted upwardly when moved to the released position.

12. The 3D printer of claim 11, wherein the plurality of moveable elements comprise holders each including a receptacle in which a cylindrical bearing is provided, the cylindrical bearing to cause lifting of a given holder of the holders due to one of:
engagement of the cylindrical bearing with a bearing surface as the given holder is moved to the released position, and
movement of a shaft of the cylindrical bearing along an inclined slot.

13. The 3D printer of claim 9, further comprising a single motor to rotate the rotatable shaft.

14. The 3D printer of claim 9, further comprising rods connecting the actuator and the plurality of moveable elements.

15. A method of forming a printer assembly for use in a printer, comprising:
mounting a plurality of extruders on a rotatable shaft to feed respective filaments for deposition during a printing process;
coupling a motor to the rotatable shaft, the motor when activated rotating the rotatable shaft to cause rotation of the plurality of extruders for feeding the respective filaments in a feed direction; and
arranging holders each moveable between a first position and a second position, each respective holder of the holders when in the first position causing a respective filament of the filaments to be engaged to a respective extruder of the plurality of extruders, and the respective holder when in the second position causing the respective filament to be disengaged from the respective extruder.
